(19) United States
(12) Patent Application Publication
(10) Pub. No.: US 2011/0075323 A1
(43) Pub. Date: Mar. 31, 2011

(54) CAPACITOR

(75) Inventors: Takahiro Kawakami, Atsugi (JP); Nadine Takahashi, Atsugi (JP)

(73) Assignee: SEMICONDUCTOR ENERGY LABORATORY CO., LTD., Atsugi-shi (JP)

(21) Appl. No.: 12/893,446

(22) Filed: Sep. 29, 2010

(30) Foreign Application Priority Data
Sep. 30, 2009 (JP) 2009-226135

(51) Int. Cl. H01G 9/145

(52) U.S. Cl. 361/503; 977/762; 977/742; 977/932; 977/750

(57) ABSTRACT

A capacitor having stable characteristics and an improved energy density while sufficiently ensuring a bonding strength between the polarizable electrode layer and the current collector is provided. A buffer layer including a ratio of 60 wt % to 90 wt %, preferably 70 wt % to 80 wt %, of carbon nanofiber or carbon nanotube, is formed over the current collector. Then, by forming a polarizable electrode layer over the aforesaid buffer layer, a pair of electrodes are obtained in which, the buffer layer and the polarizable electrode layer are stacked in this order over the current collector. Additionally, a capacitor is formed with the above-mentioned pair of electrodes by opposing the polarizable electrode layers to each other so as to be facing one another with a separator sandwiched therebetween in an electrolyte solution.

### BACKGROUND OF THE INVENTION

1. Field of the Invention

The present invention relates to hybrid capacitors such as an electric double layer capacitor and a lithium ion capacitor.

2. Description of the Related Art

In such capacitors as that of an electric double layer capacitor and a lithium ion capacitor, since a dielectric can be made thin to the molecular level, and because a surface area of the electrode can be enlarged per unit area by a porous activated carbon, an extremely large capacitance of several F to several thousand F can be obtained. Further, since a charge and discharge of the above-mentioned capacitor is fast and because its power density exceeds 1 kW/kg, great electrical power can be supplied instantaneously. Additionally, since deterioration from charging and discharging is small, reliability of the capacitor is high. Also, since the internal resistance of approximately several mΩ is low, loss of charge is small, and because the capacitor does not generate heat easily, the safety of the capacitor is high. For these reasons, the capacitor is tested for practical use in a variety of applications such as power storage for power generated by solar and wind power, an auxiliary power supply for vehicles, and a backup power supply for electronic devices.

The capacitor has a structure in which a pair of electrodes oppose each other with a separator sandwiched therebetween in an electrolyte solution and polarizable electrode layers including an active material are stacked over current collectors such as aluminum. When a voltage is applied between the pair of opposing electrodes, depending on an electric field, anions in the electrolyte solution are drawn to a positive electrode side, and cations are drawn to the negative electrode side. As a result, an electric double layer having a capacitance is formed in the vicinity of the interface between the electrodes and the electrolyte solution.

Polarizable electrode layers used in the electrodes mainly includes an activated carbon which is an active material, a binder which binds the active material, and a conductive agent for increasing conductivity of the polarizable electrode layers. Additionally, by mixing the above-mentioned materials of activated carbon, binder and a conductive agent, a composite slurry is obtained and coated over the current collector, such as aluminum, and then dried. After drying, an electrode for a capacitor in which a polarizable electrode layer is laminated over a current collector is formed by performing a pressing treatment using a pressing machine that applies a pressure thereto. In this way, a production cost of a capacitor can be suppressed since an electrode formed by a coating method in which a composition is coated has a high yield rate as well as a fast production speed, in comparison to an electrode formed by a pressure extension method in which a polarizable electrode layer formed by pressure extension is attached to a current collector using an adhesive.

The below mentioned Patent Document 1 describes a capacitor using an electrode formed by a coating method.

### REFERENCE

### Patent Document

### [Patent Document 1] Japanese Published Patent Application No. 2007-080844

### SUMMARY OF THE INVENTION

In the pressing treatment performed in the above-mentioned coating method, a polarizable electrode layer with a uniform thickness is formed to stabilize the characteristics of a capacitor. On the other hand, by increasing a density of the active material, the bonds between activated carbons is promoted to lower the resistance of the electrode; thus, the energy density of the capacitor is improved. For these reasons, the pressing treatment is one process that is extremely important for controlling the performance of the capacitor. However, if a pressure of the pressing treatment is raised too much in order to ensure uniformity of the polarizable electrode layer, or to increase a density of the active material, the bonding strength between the polarizable electrode layer and the current collector drops, and after performing the pressing treatment, the polarizable electrode layer easily peels away from the current collector.

By increasing the ratio of the binder used in the polarizable electrode layer, the bonding strength between the polarizable electrode layer and the current collector can be increased to some extent. However, the binder itself is in many cases an insulator. Accordingly, when a ratio of the binder is simply increased for increasing the bonding strength, an internal resistance of the capacitor is increased by the resistance of the electrode being increased, and the merit of the capacitor to be able to charge and discharge in a short amount of time is inhibited.

In view of the above problems, it is an object of the present invention to provide a method of manufacturing a capacitor in which a pressing treatment can ensure uniformity of a polarizable electrode layer, can apply approximately enough pressure to sufficiently raise a density of an active material, and can prevent peeling of the polarizable electrode layer from the current collector. Further, in view of the above problems, it is an object of the present invention to provide a capacitor having stable characteristics and an improved energy density while sufficiently ensuring a bonding strength between the polarizable electrode layer and the current collector.

A buffer layer including a ratio of 60 wt % to 90 wt %, preferably 70 wt % to 80 wt %, of a carbon nanofiber or a carbon nanotube, is formed over the current collector. Then, by forming a polarizable electrode layer over the buffer layer, an electrode is obtained in which, the buffer layer and the polarizable electrode layer are stacked in this order over the current collector. Additionally, a capacitor is formed with two of the above-mentioned electrodes by opposing the polarizable electrode layers to each other so as to be facing one another with a separator sandwiched therebetween in an electrolyte solution.

The category of a carbon nanofiber includes fiber shaped carbons which have a length of several μm to several hundred μm and a fiber cross-section in which the longest diameter is 10 nm to 1000 nm. The cross-section may be circular, elliptical, rectangular or polygonal shape. The category of a carbon nanotube includes fiber shaped carbons which have a length of several tens of nm to several μm and a fiber cross-section in which the longest diameter is 1 nm to 10 nm. The shape of the cross-section is generally circular.

Specifically, the buffer layer can be formed by coating a composite material that can be obtained by mixing a carbon nanofiber or a carbon nanotube with a resin which functions as a binder, over the current collector, and dried. Additionally, the polarizable electrode layer can be formed by coating a composite material that can be obtained by mixing an activated carbon which is an active material with a resin which functions as a binder, over the above-mentioned buffer layer, and dried. Then, a pressure is applied by performing a pressing treatment. When the pressing treatment is performed, a heat treatment may be performed at the same time.

Further, to increase a conductivity of the above-mentioned buffer layer and the polarizable electrode layer, each layer may include a conductive agent.

Note that the capacitor may be an electric double layer capacitor, or may be a hybrid capacitor in which one of the electrodes of the pair of electrodes has an electric double layer and the other electrode uses an oxidation-reduction reaction. The category of hybrid capacitors, for example, includes a lithium ion capacitor in which a positive electrode has an electric double layer structure, and a negative electrode has a lithium ion secondary battery structure.

In an embodiment of the present invention, according to the above-mentioned structure, the capacitor is formed in which uniformity of a polarizable electrode layer is ensured, approximately enough pressure can be applied so that a density of an active material can be sufficiently raised, and peeling of the polarizable electrode layer from a current collector can be prevented. Further, according to an embodiment of the present invention, while sufficiently ensuring a bonding strength between the polarizable electrode layer and the current collector, a capacitor having stable characteristics and an improved energy density can be obtained.

### BRIEF DESCRIPTION OF THE DRAWINGS

FIG. 1 is a schematic view illustrating a structure of an electric double layer capacitor.

FIGS. 2A to 2C illustrate a manufacturing method of a capacitor.

FIG. 3 is a schematic view illustrating a structure of a lithium ion capacitor.

FIGS. 4A to 4C illustrate structures of a staked layer capacitor.

FIGS. 5A and 5B illustrate structures of a coin capacitor.

### DETAILED DESCRIPTION OF THE INVENTION

Hereinafter, embodiments of the present invention will be described in detail with reference to the accompanying drawings. However, the present invention is not limited to the following description and it is easily understood by those skilled in the art that the embodiments and details can be variously changed without departing from the scope and spirit of the present invention. Accordingly, the present invention should not be construed as being limited to the description of the embodiments herein.

### Embodiment 1

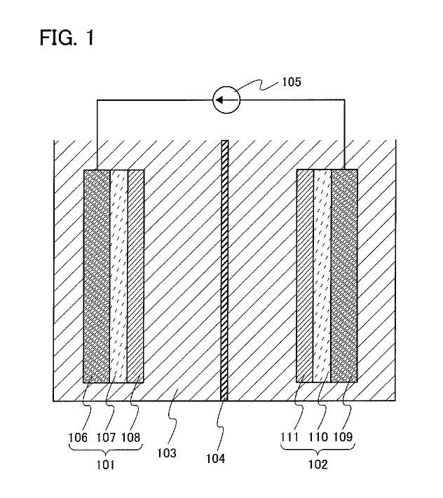

According to an embodiment of the present invention, a structure of an electric double layer capacitor with reference to FIG. 1 is described. The capacitor shown in FIG. 1 includes an electrode 101 and an electrode 102 which oppose each other with a separator 104 sandwiched therebetween in an electrolyte solution 103. The electrode 101 has a current collector 106, a buffer layer 107 in contact with the current collector 106, and a polarizable electrode layer 108 in contact with the buffer layer 107. The buffer layer 107 is provided between the current collector 106 and the polarizable electrode layer 108. In a similar manner, the electrode 102 has a current collector 109, a buffer layer 110 in contact with the current collector 109, and a polarizable electrode layer 111 in contact with the buffer layer 110. The buffer layer 110 is provided between the current collector 109 and the polarizable electrode layer 111. Also, the polarizable electrode layer 108 and the polarizable electrode layer 111 face one another.

It is preferable that the current collector 106 and the current collector 109 have a high electrical conductivity and use a metal material which is stable in the electrolyte solution 103. For example, as the current collector 106 and the current collector 109, a metal such as aluminum, nickel, copper, iron, tungsten, gold, platinum, titanium, an alloy material mainly containing these metal materials, and, other than stainless steel, a conductive resin or the like can be used. The current collector 106 and the current collector 109 are preferably a thin flat extended foil like shape, referred to as a sheet shape or a film shape, of the above-mentioned materials. A current can be extracted outside the capacitor from the current collector 106 and the current collector 109.

Note that to increase a bonding strength of the current collector 106 and the buffer layer 107, a surface of the current collector 106 on the side of the buffer layer 107 may be formed with minute depressions and projections by etching or the like. Also, to increase a bonding strength of the current collector 109 and the buffer layer 110, a surface of the current collector 109 on the side of the buffer layer 110 may be formed with minute depressions and projections by etching or the like.

The polarizable electrode layer 108 and the polarizable electrode layer 111 use an active material such as an activated carbon, and a resin which functions as a binder for binding the active material. A conductive agent may be added to lower a resistance of the polarizable electrode layer 108 and the polarizable electrode layer 111. Since a specific surface area per one gram of the activated carbon is several hundred m² to several thousand m² and is extremely large, by using the activated carbon as the active material of the polarizable electrode layer 108 and the polarizable electrode layer 111, the capacitance of the capacitor can be increased.

The conductive agent added to the polarizable electrode layer 108 and the polarizable electrode layer 111 is a material which can lower the resistance of the polarizable electrode layer 108 and the polarizable electrode layer 111, for example, a carbon black such as acetylene black, ketjenblack, furnace black, and channel black; graphite; a carbon nanotube; and a carbon nanofiber can be used. Additionally, fine metal particles and metal fibers of such metals as aluminum, nickel, copper, and silver can be used as the conductive agent.

A material which can bind the activated carbon is used as the resin which functions as a binder. For example, a fluorine-based binder such as polytetrafluoroethylene (PTFE) and polyvinylidene fluoride (PVDF); an elastomer-based binder such as styrene-butadiene rubber (SBR), ethylene-propylene-diene monomer rubber (EPDM), acrylonitrile-butadiene rubber (ABR), and nitrile rubber (NBR); carboxymethylcellulose (CMC); and other materials known to be used as binders can be used for the binder.

The buffer layer 107 and the buffer layer 110 are layers including a ratio of 60 wt % to 90 wt %, preferably 70 wt % to 80 wt %, of a carbon nanofiber or a carbon nanotube. Also, other than the carbon nanofiber or the carbon nanotube, the buffer layer 107 and the buffer layer 110 include a resin which functions as a binder. A conductive agent may be added to lower the resistance of the buffer layer 107 and the buffer layer 110.

The category of a carbon nanofiber includes fiber shaped carbons which have a length of several μm to several hundred μm and a fiber cross-section in which the Longest diameter is 10 nm to 1000 nm. The cross-section may be circular, elliptical, rectangular or polygonal shape. The category of a carbon nanotube includes fiber shaped carbons which have a length of several tens of nm to several μm and a fiber cross-section in which the longest diameter is 1 nm to 10 nm. The shape of the cross-section is generally circular. The carbon nanotube may be a single-wall nanotube (SWNT) having a single layer, or may be a multi-wall nanotube (MWNT) having plural layers.

A material which can bind carbon nanaofibers or carbon nanotubes is used as the resin which functions as a binder. For example, a fluorine-based binder such as polytetrafluoroethylene (PTFE) and polyvinylidene fluoride (PVDF); an elastomer-based binder such as styrene-butadiene rubber (SBR), ethylene-propylene-diene monomer rubber (EPDM), acrylonitrile-butadiene rubber (ABR), and nitrile rubber (NBR); carboxymethylcellulose (CMC); and other materials known to be used as binders can be used for the binder.

In an embodiment of the present invention, by using the buffer layer 107 having the above-mentioned structure, a bonding strength of the current collector 106 and the polarizable electrode layer 108 is increased, and peeling of the polarizable electrode layer 108 from the current collector 106 can be prevented. Additionally, by using the buffer layer 110 having the above-mentioned structure, a bonding strength of the current collector 109 and the polarizable electrode layer 111 is increased, and peeling of the polarizable electrode layer 111 from the current collector 109 can be prevented.

The conductive agent added to the buffer layer 107 and the buffer layer 110 is a material which can lower the resistance of the buffer layer 107 and the buffer layer 110, for example, a carbon black such as acetylene black, ketjenblack, furnace black, and channel black; and graphite can be used. Additionally, fine metal particles and metal fibers of such metals as aluminum, nickel, copper, and silver can be used as the conductive agent.

The separator 104 prevents contact of the electrode 101 and the electrode 102, has ion conductivity which allows passage of cations and anions in an electrolyte solution 103, and uses a material not dissolved easily in the electrolyte solution 103. For example, as the separator 104, a synthetic resin including polypropylene, polyethylene, polyolefin, vinylon, polyester, polyamide such as nylon and aromatic polyamide, and polyimide; a cellulose fiber including regenerated cellulose fiber such as rayon and cupra; Manila hemp; craft paper; and glass fiber and the like can be used. Further, a nonwoven or woven fabric obtained by mixing and extracting a plurality of the above materials can be used.

The electrolyte solution 103 can be categorized as a solution in which an electrolyte is dissolved in a solvent, mainly an aqueous solution base and an organic base (non aqueous solution base). Examples of the solvent for the electrolyte solution 103 of an organic base include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), methylpropyl carbonate (MPC), methylisobutyl carbonate (MIBC), and dipropyl carbonate (DPC); sulfones such as sulfolane (SL) and 3-methylsulfolane (MSL); a nitrile such as acetonitrile; an alcohol such as methanols; acyclic carboxylic acid esters such as methyl formate, methyl acetate, methyl propionate, and ethyl propionate; cyclic esters such as γ-butyrolactone and γ-valerolactone; acyclic ethers such as dimethoxymethane, 1,2-dimethoxyethane (DME), 1,2-diethoxyethane (DEE), and ethoxymethoxy ethane (EME); cyclic ethers such as tetrahydrofuran, 2-methyltetrahydrofuran, and tetrahydropyran; dimethylsulfoxide, 1,3-dioxolane and the like; alkyl phosphate esters such as trimethyl phosphate, triethyl phosphate, and trioctyl phosphate, and fluorides thereof. All of the above solvents can be used either alone or in combination as the electrolyte solution 103.

Additionally, an ion compound such as tetrafluoroborate (BF₄), hexafluorophosphate (PF₆), perchlorate (ClO₄), and bis(trifluoromethylsulfonyl)imide ((CF₃SO₂)₂N) can be used for an electrolyte in the anion side. In addition, other than lithium, such types of ammonium as, for example, triethylmethylammonium, tetramethylammonium (CH₃)₄N, tetraethylammonium ((C₂H₅)₄N), and a type of amidine as, for example, ethylmethylimidazolium, can be used in the cation side. The concentration of the electrolyte is 0.1 mol/l to 5 mol/l or more preferably 1 mol/l to 1.5 mol/l.

Since it is preferable to combine an electrolyte and a solvent in which the solubility of the electrolyte in the solvent is high and ionization is easy; therefore, in consideration of this, a combination of the above-mentioned electrolytes and solvents is decided.

Note that a high molecular polymer and the organic plasticizer may be added to the above-mentioned solvent, and the electrolyte solution may be made to have a gel property.

Additionally, an ionic liquid that is in a state of liquid of an electrolyte which does not use a solvent may be used as the electrolyte solution 103. For example, 1-ethyl-3-methylimidazole cation, tetrafluoroborate ion (BF₄⁻), and hexafluorophosphate anion (PF₆⁻), can be used in the ionic liquid.

In FIG. 1, the charger 105 provided on the outside of the capacitor is connected to the current collector 106 and the current collector 109. The charger 105 is a current source, and by supplying a current between the electrode 101 and the electrode 102 from the charger 105, anions are drawn to the side of the electrode 101 which is a positive electrode, and cations are drawn to the side of the electrode 102 which is a negative electrode, in the electrolyte solution 103. As a result, since an electric double layer having capacitance is formed in the vicinity of the interface between the electrode 101 and the electrolyte solution 103 and in the vicinity of the interface between the electrode 102 and the electrolyte solution 103, respectively, a charge is accumulated in the capacitor.

Note that, by the discharge of charge accumulated in the electric double layer when the electrode 101 and the electrode 102 are connected to a load after charging, a current flows in the opposite direction from that of when being charged from the charger 105.

Note that in the present embodiment, a structure of a capacitor in which a polarizable electrode layer is formed on only one side of the current collector is described; however, the present invention is not limited to this structure. The polarizable electrode layer may be formed on both sides of the current collector. Also in this case, buffer layers are provided between the polarizable electrode layers and the current collector.

### Embodiment 2

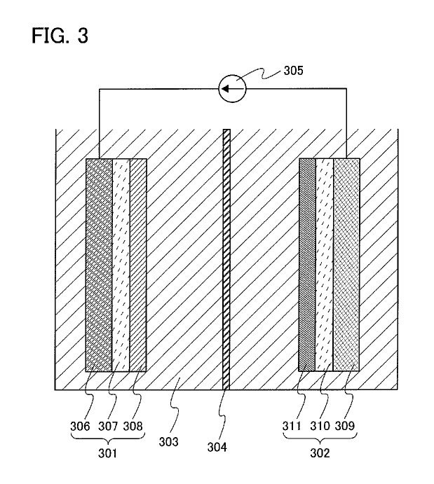

According to an embodiment of the present invention, a structure of a lithium ion capacitor with reference to FIG. 3 is described. The capacitor shown in FIG. 3 includes an electrode 301 and an electrode 302 which oppose each other with a separator 304 sandwiched therebetween in an electrolyte solution 303. The electrode 301 has a current collector 306, a buffer layer 307 in contact with the current collector 306, and a polarizable electrode layer 308 in contact with the buffer layer 307. The buffer layer 307 is provided between the current collector 306 and the polarizable electrode layer 308. In a similar manner, the electrode 302 has a current collector 309, a buffer layer 310 in contact with the current collector 309, and a polarizable electrode layer 311 in contact with the buffer layer 310. The buffer layer 310 is provided between the current collector 309 and the polarizable electrode layer 311. Also, the polarizable electrode layer 308 and the polarizable electrode layer 311 face one another.

Similar to the current collector 106 and the current collector 109 described in Embodiment 1, it is preferable that the current collector 306 and the current collector 309 have a high electrical conductivity and use a metal material which is stable in the electrolyte solution 303. For example, as the current collector 306 and the current collector 309, a metal such as aluminum, nickel, copper, iron, tungsten, gold, platinum, titanium, an alloy material mainly containing these metal materials, and, other than stainless steel, a conductive resin or the like can be used. The current collector 306 and the current collector 309 are preferably a thin flat extended foil like shape, referred to as a sheet shape or a film shape, of the above-mentioned materials. A current can be extracted outside the capacitor from the current collector 306 and the current collector 309.

Note that to increase a bonding strength of the current collector 306 and the buffer layer 307, a surface of the current collector 306 on the side of the buffer layer 307 may be formed with minute depressions and projections by etching or the like. Also, to increase a bonding strength of the current collector 309 and the buffer layer 310, a surface of the current collector 309 on the side of the buffer layer 310 may be formed with minute depressions and projections by etching or the like.

The polarizable electrode layer 308 and the polarizable electrode layer 311 which are similar to the polarizable electrode layer 108 and the polarizable electrode layer 111 described in Embodiment 1, use an active material, for example an activated carbon, and a resin which functions as a binder for binding the active material. However, lithium ion is inserted to the polarizable electrode layer 311 of the electrode 302 which corresponds to the negative electrode. Lithium ion insertion can be performed using a known pre-doping process. The pre-doping process can be performed, for example, by applying a voltage of 0.1 volt to several volts between the above-mentioned electrode 302 and a reference electrode in a separately prepared an electrolyte solution including lithium ion. Alternatively, by performing cell assembly in which, in the electrolyte solution 303, the electrode 301, which is a positive electrode formed separately, is opposed to a polarizable electrode layer 311 on which a lithium film has been pressure bonded to cause a short-circuit, and in this state a separator 304 is sandwiched therebetween, the pre-doping process and cell assembly can be concurrently carried out.

A conductive agent may be added to lower a resistance of the polarizable electrode layer 308 and the polarizable electrode layer 311. Since a specific surface area per one gram of the activated carbon is several hundred m² to several thousand m² and is extremely large, by using the activated carbon as the active material of the polarizable electrode layer 308 and the polarizable electrode layer 311, the capacitance of the capacitor can be increased.

Similar to the polarizable electrode layer 108 and the polarizable electrode layer 111 described in Embodiment 1, the conductive agent added to the polarizable electrode layer 308 and the polarizable electrode layer 311 is a material which can lower the resistance of the polarizable electrode layer 308 and the polarizable electrode layer 311, for example, a carbon black such as acetylene black, ketjenblack, furnace black, and channel black; graphite; a carbon nanotube; and a carbon nanofiber can be used. Additionally, fine metal particles and metal fibers of such metals as aluminum, nickel, copper, and silver can be used as the conductive agent.

A material which can bind the activated carbon is used as the resin which functions as a binder. For example, a fluorine-based binder such as polytetrafluoroethylene (PTFE) and polyvinylidene fluoride (PVDF); an elastomer-based binder such as styrene-butadiene rubber (SBR), ethylene-propylene-diene monomer rubber (EPDM), acrylonitrile-butadiene rubber (ABR), and nitrile rubber (NBR); carboxymethylcellulose (CMC); and other materials known to be used as binders can be used for the binder.

The buffer layer 307 and the buffer layer 310 are layers including a ratio of 60 wt % to 90 wt %, preferably 70 wt % to 80 wt %, of a carbon nanofiber or a carbon nanotube. Also, other than the carbon nanofiber or the carbon nanotube, the buffer layer 307 and the buffer layer 310 include a resin which functions as a binder. A conductive agent may be added to lower the resistance of the buffer layer 307 and the buffer layer 310.

The category of a carbon nanofiber includes fiber shaped carbons which have a length of several μm to several hundred μm and a fiber cross-section in which the longest diameter is 10 nm to 1000 nm. The cross-section may be circular, elliptical, rectangular or polygonal shape. The category of a carbon nanotube includes fiber shaped carbons which have a length of several tens of nm to several μm and a fiber cross-section in which the longest diameter is 1 nm to 10 nm. The shape of the cross-section is generally circular. The carbon nanotube may be single-wall nanotube (SWNT) having a single layer, or may be a multi-wall nanotube (MWNT) having plural layers.

A material which can bind carbon nanaofibers or carbon nanotubes is used as the resin which functions as a binder. For example, a fluorine-based binder such as polytetrafluoroethylene (PTFE) and polyvinylidene fluoride (PVDF); an elastomer-based binder such as styrene-butadiene rubber (SBR), ethylene-propylene-diene monomer rubber (EPDM), acrylonitrile-butadiene rubber (ABR), and nitrile rubber (NBR); carboxymethylcellulose (CMC); and other materials known to be used as binders can be used for the binder.

In an embodiment of the present invention, by using the buffer layer 307 having the above-mentioned structure, a bonding strength of the current collector 306 and the polarizable electrode layer 308 is increased, and peeling of the polarizable electrode layer 308 from the current collector 306 can be prevented. Additionally, by using the buffer layer 310 having the above-mentioned structure, a bonding strength of the current collector 309 and the polarizable electrode layer 311 is increased, and peeling of the polarizable electrode layer 311 from the current collector 309 can be prevented.

The conductive agent added to the buffer layer 307 and the buffer layer 310 is a material which can lower the resistance of the buffer layer 307 and the buffer layer 310, for example, a carbon black such as acetylene black, ketjenblack, furnace black, and channel black; and graphite can be used. Additionally, fine metal particles and metal fibers of such metals as aluminum, nickel, copper, and silver can be used as the conductive agent.

The separator 304 prevents contact of the electrode 301 and the electrode 302, has ion conductivity which allows passage of cations and anions in an electrolyte solution 303, and uses a material not dissolved easily in the electrolyte solution 303. For example, as the separator 304, a synthetic resin including polypropylene, polyethylene, polyolefin, vinylon, polyester, polyamide such as nylon and aromatic polyamide, and polyimide; a cellulose fiber including regenerated cellulose fiber such as rayon and cupra; Manila hemp; craft paper; and glass fiber and the like can be used. Further, a nonwoven or woven fabric obtained by mixing and extracting a plurality of the above materials can be used.

The electrolyte solution 303 can be categorized as a solution in which an electrolyte is dissolved in a solvent, mainly an aqueous solution base and an organic base (non aqueous solution base). Examples of the solvent for the electrolyte solution 303 of an organic base include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), methylpropyl carbonate (MPC), methylisobutyl carbonate (MIBC), and dipropyl carbonate (DPC); sulfones such as sulfolane (SL) and 3-methylsulfolane (MSL); a nitrile such as acetonitrile; an alcohol such as methanols; acyclic carboxylic acid esters such as methyl formate, methyl acetate, methyl propionate, and ethyl propionate; cyclic esters such as γ-butyrolactone and γ-valerolactone; acyclic ethers such as dimethoxymethane, 1,2-dimethoxyethane (DME), 1,2-diethoxyethane (DEE), and ethoxymethoxy ethane (EME); cyclic ethers such as tetrahydrofuran, 2-methyltetrahydrofuran, and tetrahydropyran; dimethylsulfoxide, 1,3-dioxolane and the like; alkyl phosphate esters such as trimethyl phosphate, triethyl phosphate, and trioctyl phosphate, and fluorides thereof. All of the above solvents can be used either alone or in combination as the electrolyte solution 303.

Additionally, an ion compound used for an electrolyte can be a lithium salt, for example, lithium chloride (LiCl), lithium fluoride (LiF), lithium perchlorate (LiClO₄), lithium fluoroborate (LiBF₄), lithium hexafluoroarsenate (LiAsF₆), lithium hexafluorophosphate (LiPF₆), and lithium bis(trifluoromethanesulfonyl) imide (LiN(CF₃SO₂)₂), all of which can be used either alone or in combination in the electrolyte. The concentration of the electrolyte is 0.1 mol/l to 5 mol/l or more preferably 1 mol/l to 1.5 mol/l.

A combination of the above-mentioned electrolytes and solvents is decided while considering that it is preferable to combine an electrolyte and a solvent in which the solubility of the electrolyte in the solvent is high and ionization is easy.

Note that a high molecular polymer and the organic plasticizer may be added to the above-mentioned solvent, and the electrolyte solution may be made to have a gel property.

In FIG. 3, the charger 305 provided on the outside of the capacitor is connected to the current collector 306 and the current collector 309. The charger 305 is a current source, and by supplying a current between the electrode 301 and the electrode 302 from the charger 305, anions are drawn to the side of the electrode 301 which is a positive electrode, and cations are drawn to the side of the electrode 302 which is a negative electrode, in the electrolyte solution 303. As a result, in the vicinity of the interface between the electrode 301 and the electrolyte solution 303 and in the vicinity of the interface between the electrode 302 and the electrolyte solution 303, since electric double layers are formed having capacitance, a charge is accumulated in the capacitor. Additionally, by a chemical reaction of carbon in the polarizable electrode layer 311 of the electrode 302 which is a negative electrode with the lithium ion in the electrolyte solution 303, charging of the lithium capacitor is performed. Specifically, a bond of the lithium ion and carbon is promoted during charging. Since a capacitance of the negative electrode is increased by the lithium ion included in the polarizable electrode layer 311 of the electrode 302 which is a negative electrode, an energy density of the lithium ion capacitor in comparison to an electric double layer capacitor is high.

Note that, by the discharge of charge accumulated in the electric double layer and by breakage of the bond of the carbon and the lithium ion in the electrode 302 when the electrode 301 and the electrode 302 are connected to a load after charging, a current flows in the opposite direction from that of when being charged from the charger 305.

Note that in the present embodiment, a structure of a capacitor in which a polarizable electrode layer is formed on only one side of the current collector is described; however, the present invention is not limited to this structure. The polarizable electrode layer may be formed on both sides of the current collector. Also in this case, buffer layers are provided between the polarizable electrode layers and the current collector.

In the present invention, the above described embodiment can be combined with any of the other embodiments.

### Embodiment 3

In this embodiment, a method of manufacturing an electrode included in a capacitor according to an embodiment of the present invention is described.

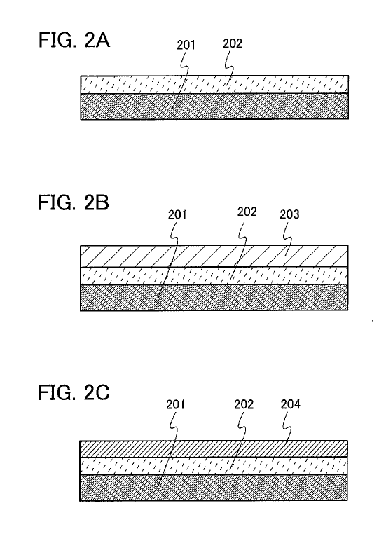

First, a buffer layer 202 is formed on the current collector 201 as shown in FIG. 2A.

The specific examples of the current collector 106 and the current collector 109 described in Embodiment 1 can be used for the current collector 201. In this embodiment, an aluminum foil can be used as the current collector 201.

The buffer layer 202, as described in Embodiment 1, includes a ratio of 60 wt % to 90 wt %, preferably 70 wt % to 80 wt %, of a carbon nanofiber or a carbon nanotube. Further, other than the carbon nanofiber and the carbon nanotube, the buffer layer 202 includes a resin which functions as a binder.

In this embodiment, by mixing VGCF (registered trademark) manufactured by Showa Denko K.K. which is a gas-phase method carbon fiber, with polyvinylidene fluoride (PVDF) which functions as a binder, and N-methylpyrrolidone (NMP) which is a solvent, a composite of a slurry mixture is obtained and coated over the current collector 201. In the state of the slurry mixture, before coating on the current collector 201, the weight ratio of VGCF and PVDF was 71.4 wt % and 28.6 wt %, respectively. Alternatively, the mixture formed by a carbon nanofiber or a carbon nanotube plus a binder has a weight ratio to the solvent of 1 to 4.

Note that it is preferred to adjust an amount of the solvent used in the composite which becomes the buffer layer 202, so that the composite is a concentration of a solid and can obtain an approximate sufficient fluidity for being coated evenly over the current collector 201. Additionally, it is preferable to adjust the amount of the solvent so that the film obtained by coating the composite is a thickness of 5 μm to 20 μm before being dried.

Further, the solvent, without being limited to the above-mentioned materials, may be a solvent in which the carbon nanofiber or the carbon nanotube and the binder is sufficiently dispersed in the liquid, is chemically stable and obtains a viscosity of approximately that which can be made into a film. For example, other than the N-methylpyrrolidone (NMP), xylene, water and the like may be used.

Specifically, the composite which becomes the buffer layer 202 is manufactured by first mixing VGCF with PVDF for 15 minutes, and then NMP which is the solvent is added and mixed for 15 minutes. Mixing is performed by a mechanical alloying method (MA method) using a ball milling apparatus from Ito Seisakusho Co., Ltd. Specifically, the composite is manufactured by sealing φ5 mm balls and the material for the composite in a milling pot in an inert gas atmosphere, and the milling pot is rotated at a speed of 300 rpm.

Note that in this embodiment, a ball milling apparatus is used to manufacture the composite which becomes the buffer layer 202, but the present invention is not limited thereto. For example, a roll mill apparatus, pebble mill apparatus, a sand mill apparatus, and other agitation or kneading apparatuses can be used for manufacturing the composite.

In coating the composite which becomes the buffer layer 202, a known coating method such as a printing method using a metal mask, a dip coating method, a spray coating method, a roll coating method, the doctor blade method, a gravure coating method, or a screen printing method can be used. In this embodiment, the doctor blade method is used to coat the composite which becomes the buffer layer 202 to the current collector 201.

The mixture of VGCF and PVDF is coated over the current collector 201 and then dried, thereby forming the buffer layer 202 having a thickness of 8 μm. Specifically, in this embodiment, drying is performed by a heat treatment at 120° C. for 30 minutes under an air atmosphere.

Next, the composite for forming the polarizable electrode layer is coated over the buffer layer 202 and then dried to manufacture the polarizable electrode layer 203, as shown in FIG. 2B. The composite for forming the polarizable electrode layer is a slurry mixture obtained by mixing together the activated carbon which is an active material, a resin which functions as a binder, and a solvent. A conductive agent may also be added to the above-mentioned composite.

In this embodiment, a composite is formed by mixing a mixture of the activated carbon which is an active material, the VGCF which is a conductive agent, PVDF which is a binder, having a weight ratio of 84.1 wt %, 7 wt %, 8.9 wt %, respectively, and additionally adding N-methylpyrrolidone (NMP) as a solvent. The mixture which is formed by the active material, the conductive agent plus the binder, has a weight ratio to the solvent of 1 to 4.

Furthermore, the weight ratio of the active material, the conductive agent, and the binder described in this embodiment is not limited thereto. For example, the active material is 70 wt % or more and 90 wt % or less, the conductive agent is 3 wt % or more and 10 wt % or less, the binder is 10 wt % or more and 20 wt % or less, and a composition of each material does not exceed a total weight ratio of 100 wt %.

Note that it is preferred to adjust an amount of the solvent used in the composite for forming the polarizable electrode layer, so that the composite is a concentration of a solid and can obtain an approximate sufficient fluidity for being coated evenly over the buffer layer 202. Additionally, it is preferable to adjust the amount of the solvent so that the film obtained by coating the composite is a thickness of 50 μm to 300 μm before being dried.

Further, the solvent, without being limited to the above-mentioned materials, may be a solvent in which the active material, the conductive agent, and the binder are sufficiently dispersed in the liquid, is chemically stable, and obtains a viscosity of approximately that which can be made into a film. For example, other than the N-methylpyrrolidone (NMP), xylene, water and the like may be used.

Specifically, the composite for forming the polarizable electrode layer is manufactured by first mixing activated carbon with VGCF for 15 minutes, then adding PVDF and mixing for an additional 15 minutes, after that, NMP which is the solvent is then added and mixed for 15 minutes. Mixing is performed by a mechanical alloying method (MA method) using a ball milling apparatus from Ito Seisakusho Co., Ltd. Specifically, the composite is manufactured by sealing φ5 mm balls and the material for the composite in a milling pot in an inert gas atmosphere, and the milling pot is rotated at a speed of 300 rpm.

Note that to adjust the viscosity of the composite for forming the polarizable electrode layer, a thickening agent such as a water-soluble polymer may be added. In this case, the conductive agent and the thickening agent are mixed together, then the active material is mixed in, the binder is mixed in after that, and lastly, a solvent may be added and mixed. The conductive agent can be more evenly dispersed in the solvent by the conductive agent first being mixed with the thickening agent which is a liquid, rather than a procedure in which the conductive agent and the active material having different particle diameter to the conductive agent are mixed first. Accordingly, a polarizable electrode layer having low resistance can be obtained while an amount of the conductive agent can be suppressed.

Note that in this embodiment, a ball milling apparatus is used to manufacture the composite for forming the polarizable electrode layer, but the present invention is not limited thereto. For example, a roll mill apparatus, pebble mill apparatus, a sand mill apparatus, and other agitation or kneading apparatuses can be used for manufacturing the composite.

The same method for coating the composite which becomes the buffer layer 202 can be used in coating the composite for forming the polarizable electrode layer. For example, a known coating method such as a printing method using a metal mask, a dip coating method, a spray coating method, a roll coating method, the doctor blade method, a gravure coating method, or a screen printing method can be used. In this embodiment, the doctor blade method is used to coat the composite for forming the polarizable electrode layer to the buffer layer 202.

The composite for forming the polarizable electrode layer is coated over the buffer layer 202 and then dried, thereby forming the polarizable electrode layer 203 having a thickness of 158 μm. Specifically, in this embodiment, drying is performed by a heat treatment at 120° C. for 30 minutes under an air atmosphere.

Next, a polarizable electrode layer 204 is manufactured by a pressing treatment which applies a pressure to the polarizable electrode layer 203, thereby improving a density of the activated carbon which is an active material, and increasing the evenness of the polarizable electrode layer 204, as shown in FIG. 2C. When the pressing treatment is performed, a heat treatment may be performed at the same time. By performing the pressing treatment, a polarizable electrode layer with a uniform thickness is formed to stabilize the characteristics of a capacitor. On the other hand, by increasing a density of the active material, the bonds between activated carbons is promoted to lower the resistance of the electrode; thus, the energy density of the capacitor is improved.

In the present embodiment, a polarizable electrode layer 204 having a film thickness of 94 μm is formed by applying a pressure using a roller press machine, and a volume of the polarizable electrode layer 204 after the pressing treatment becomes approximately 70% or more and 80% or less of a volume of the polarizable electrode layer 203 before the pressing treatment. Note that by improving a density of the active material in the polarizable electrode layer by a pressing treatment, the benefit that the resistance of the electrode can be lowered is obtained; however, if the density of the active material is increased too much, it becomes difficult for the electrolyte solution to penetrate into the polarizable electrode layer, it becomes difficult to form the electric double layer, and the capacitance drops. Therefore, it is preferable that a density of the active material in the polarizable electrode layer 204 after the pressing treatment is approximately 0.5 kg/cm³ to 0.8 kg/cm³.

Additionally, after the pressing treatment, the weight ratio of the VGCF in the buffer layer 202 is 60 wt % to 90 wt %, preferably 70 wt % to 80 wt %, which determines the weight ratio of the composite which forms the buffer layer 202.

By using the above-mentioned process, depending on the buffer layer 202, an electrode in which a bonding strength between the polarizable electrode layer 204 and the current collector 201 is increased, can be formed.

Note that as the buffer layer, acetylene black (AB) was used instead of VGCF, and a bonding strength of the current collector and the polarizable electrode layer was examined. Specifically, a buffer layer is formed by mixing AB, PVDF which is a binder, and NMP which is a solvent, to form a composite which is a slurry mixture that is coated over the current collector which is an aluminum film and dried. For the AB, Denka Black (registered trademark) which is a product name of Denki Kagaku Kogyo Kabushiki Kaisha was used. Experiments were carried out in which the weight ratio of AB and PVDF in a state of a slurry mixture was a combination of 90 to 10, 80 to 20, and 70 to 30. Additionally, the mixture formed of AB and PVDF has a weight ratio to the solvent of 1 to 4. After that, when the polarizable electrode layer is manufactured and the pressing treatment is performed in a similar manner according to the aforesaid process, adhesiveness of the polarizable electrode layer is bad; thus, it is understood that even if AB is used in the buffer layer, a sufficient bonding strength cannot be obtained.

Similarly, as the buffer layer, ketjenblack (KB) was used instead of VGCF, and a bonding strength of the current collector and the polarizable electrode layer was examined. Specifically, a buffer layer is formed by mixing KB, PVDF which is a binder, and NMP which is a solvent, to form a composite which is a slurry mixture that is coated over the current collector which is an aluminum film and dried. For the KB, ECP600D which is a product name of Ketjen Black International Co. Ltd. was used. Experiments were carried out in which the weight ratio of KB and PVDF in a state of a slurry mixture was a combination of 90 to 10, 80 to 20, and 70 to 30. Additionally, the mixture formed of KB and PVDF has a weight ratio to the solvent of 1 to 4. After that, when the polarizable electrode layer is manufactured and the pressing treatment is performed in a similar manner according to the aforesaid process, adhesiveness of the polarizable electrode layer is bad; thus, it is understood that even if KB is used in the buffer layer, a sufficient bonding strength cannot be obtained.

By increasing the ratio of the binder in the polarizable electrode layer or the buffer layer, it was thought that a bonding strength between the polarizable electrode layer and the current collector could be increased. However, the binder itself is in many cases an insulator. Accordingly, when a ratio of the binder is simply increased for increasing the bonding strength, the resistance of the polarizable electrode layer or the buffer layer and ultimately the combined resistance of the entire electrode is increased; thus, the internal resistance of the capacitor becomes increased, and the merit of the capacitor to be able to charge and discharge in a short amount of time is inhibited, which is not desirable.

Therefore, by simply just using a material including carbon in the buffer layer, an effect of one embodiment of the present invention cannot be obtained. It was understood that a buffer layer formed with a ratio of 60 wt % to 90 wt %, preferably 70 wt % to 80 wt %, of a carbon nanofiber or a carbon nanotube effectively ensures a sufficient bonding strength of the current collector and the polarizable electrode layer of the capacitor.

Note that an electric double layer capacitor can be formed with the formed pair of electrodes by opposing the polarizable electrode layers to each other so as to be facing one another with a separator sandwiched therebetween in an electrolyte solution.

Note that in the case of forming a lithium ion capacitor, the above-mentioned manufacturing method of the electrode is different in that lithium ion is pre-doped to the polarizable electrode layer of the electrode which becomes the negative electrode, but otherwise the lithium ion capacitor can be manufactured with reference to the above-mentioned manufacturing method. Since lithium ion is added to the negative electrode, an energy density of the lithium ion capacitor can be improved in comparison to that of the electric double layer capacitor.

In particular, the manufacturing method of the electrode of the lithium ion capacitor will be described in brief herein. First, in the present embodiment, a copper foil is used as the current collector. The specific examples of the current collector 306 and the current collector 309 described in Embodiment 2 can be used as a conductor which is used as the current collector of the negative electrode of the lithium ion capacitor. However, it is preferable to use the copper foil rather than the aluminum foil as the current collector of the negative electrode, since generation of an electric potential difference between the positive electrode and the negative electrode, and alloying of the lithium and aluminum can be prevented. Furthermore, the electrode which becomes the negative electrode is manufactured by forming the polarizable electrode layer and the buffer layer over the copper foil current collector according to the above-mentioned manufacturing method. Then, a pre-doping process is performed to insert lithium ion to the polarizable electrode layer. It is possible to perform the pre-doping process using a known method. The pre-doping process can be performed, for example, by applying a voltage of 0.1 volt to several volts between the above-mentioned electrode and a reference electrode in an electrolyte solution including lithium ion. Alternatively, the pre-doping process and cell assembly can be concurrently carried out by performing cell assembly in which, in an electrolyte solution, a polarizable electrode layer over which a lithium film has been pressure bonded to cause a short-circuit, and in this state a positive electrode formed separately opposed to the polarizable electrode layer with a separator sandwiched therebetween.

By using a manufacturing method according to an embodiment of the present invention, a capacitor is formed in which uniformity of a polarizable electrode layer is ensured, approximately enough pressure can be applied so that a density of an active material can be sufficiently raised, and peeling of the polarizable electrode layer from a current collector can be prevented.

Note that in the present embodiment, a structure of a capacitor in which a polarizable electrode layer is formed on only one side of the current collector is described; however, the present invention is not limited to this structure. The polarizable electrode layer may be formed on both sides of the current collector. Also in this case, buffer layers are provided between the polarizable electrode layers and the current collector.

In the present invention, the above described embodiment can be combined with any of the other embodiments.

### Embodiment 4

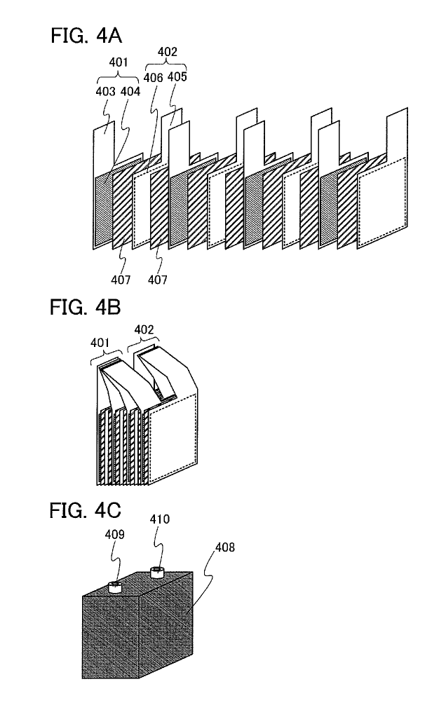

In the present embodiment, an example of a structure of a stacked layer type capacitor is described with reference to FIGS. 4A to 4C.

FIG. 4A is a perspective view in which cells formed of a pair of electrodes with a separator are stacked. An electrode 401 is a positive electrode and an electrode 402 is a negative electrode. The electrode 401 includes a polarizable electrode layer 404 formed over a current collector 403 with a buffer layer sandwiched therebetween. Furthermore, the electrode 402 includes a polarizable electrode layer 406 formed over a current collector 405 with a buffer layer sandwiched therebetween. The electrode 401 and the electrode 402 oppose each other so that the polarizable electrode layer 404 and the polarizable electrode layer 406 face one another.

Further, a separator 407 is provided between each of the electrodes 401 and electrodes 402, thereby preventing direct contact between the electrodes 401 and the electrodes 402.

Note that in FIG. 4A, the structure of the capacitor has spaces left between the electrodes 401, the electrodes 402, and the separators 407 so as to show the stacking order of the electrodes 401, the electrodes 402, and the separators 407; however, in actuality, the electrodes 401, the electrodes 402, and the separators 407 are stacked so as to be adjacent to one another, as shown in FIG. 4B. Additionally, the electrodes 401 are electrically connected to one another, and the electrodes 402 are electrically connected to one another, thus a plurality of capacitors are connected in parallel, and a capacitor with a stacked structure having a high capacitance can be obtained.

Note that when the electrodes 401, the electrodes 402, and the separators 407 are stacked as shown in FIG. 4B, the electrodes 401, the electrodes 402, and the separators 407 are sealed in a capacitor case 408 with an electrolyte solution, as shown in FIG. 4C. The case 408 has a terminal 409 connected to the electrodes 401, and a terminal 410 connected to the electrodes 402, and current can be supplied to the capacitor from the terminal 409 and the terminal 410.

Note that in the present embodiment, an example of a capacitor has a stacked structure of a plurality of cells connected in parallel, in which a single cell is formed of an electrode 401, an electrode 402, and a separator 407 sandwiched between the electrode 401 and the electrode 402; however, the present invention is not limited thereto. The capacitor may be a stacked structure in which two or more single cells are connected in series.

Further, in the present embodiment, a structure of a capacitor in which a polarizable electrode layer is formed on only one side of the current collector is described; however, the present invention is not limited to this structure. The polarizable electrode layer may be formed on both sides of the current collector. In this case, a structure in which a current collector of at least one of the electrodes of the pair is shared by an adjacent cell.

In the present invention, the above described embodiment can be combined with any of the other embodiments.

### Embodiment 5

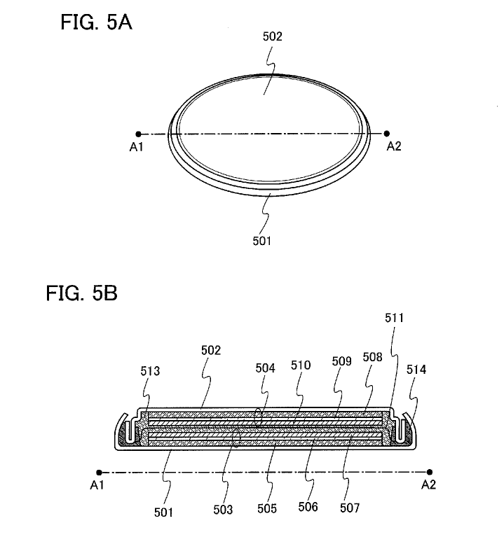

In the present embodiment, an example of a structure of a coin capacitor is described with reference to FIGS. 5A and 5B.

FIG. 5A is a perspective view of a coin capacitor, and FIG. 5B is a cross-sectional view taken along the dashed line A1-A2 shown in FIG. 5A. A positive electrode terminal 501 and a negative electrode terminal 502 are not only terminals for outputting current from the capacitor, but since a space is formed by being overlapped with each other, the positive electrode terminal 501 and the negative electrode terminal 502 also function as a metal case of the capacitor. Specifically, such metals as an alloy including aluminum or stainless steel can be used as the metal case.

Additionally, an electrode 503 includes a current collector 505, a buffer layer 506 over the current collector 505, and a polarizable electrode layer 507 over the buffer layer 506. Similarly, an electrode 504 includes a current collector 508, a buffer layer 509 over the current collector 508, and a polarizable electrode layer 510 over the buffer layer 509. A separator 511 is sandwiched between the electrode 503 and the electrode 504, and the polarizable electrode layer 507 and the polarizable electrode layer 510 oppose each other so as to be facing one another.

Note that an adhesive agent such a conductive resin is used to connect the current collector 505 to the positive terminal 501. Furthermore, an adhesive agent such a conductive resin or solder is used to connect the current collector 508 to the negative terminal 502.

A fixing sealant, also referred to as a gasket 514, is provided in the space between the positive terminal 501 and the negative terminal 502 so as to increase a watertightness and airtightness of the gap formed by the positive terminal 501 and the negative terminal 502. For the gasket 514, for example, such materials as nitrile rubber (NBR), styrene-butadiene rubber (SBR), butyl rubber, ethylene-propylene rubber (EPT), chloride butyl rubber, polyphenylene sulfide (PPS), and polyether etherketone (PEEK) may be used.

Also, the gap formed by the positive terminal 501, the negative terminal 502, and the gasket 514 is filled by an electrolyte solution 513.

In the present invention, the above described embodiment can be combined with any of the other embodiments.

This application is based on Japanese Patent Application serial no. 2009-226135 filed with Japan Patent Office on Sep. 30, 2009, the entire contents of which are hereby incorporated by reference.

What is claimed is:

1. A capacitor comprising:
a pair of electrodes,
wherein each of the pair of electrodes includes a current collector, a polarizable electrode layer, and a buffer layer provided between the current collector and the polarizable electrode layer, and
wherein the buffer layer of at least one of the pair of electrodes includes fiber shaped carbons.

2. The capacitor according to claim 1, wherein the polarizable electrode layer of at least one of the pair of electrodes is formed by a coating method.

3. The capacitor according to claim 1, wherein the fiber shaped carbons is a carbon nanofiber.

4. The capacitor according to claim 1, wherein the fiber shaped carbons is a carbon nanotube.

5. The capacitor according to claim 4,
wherein the carbon nanotube is a single-wall nanotube.

6. The capacitor according to claim 1,
wherein the buffer layer of at least one of the pair of electrodes includes 60 wt % or more and 90 wt % or less of a carbon nanofiber or a carbon nanotube.

7. The capacitor according to claim 1,
wherein the current collector of each of the pair of electrodes comprises a metal.

8. The capacitor according to claim 1,
wherein the current collector of each of the pair of electrodes is a sheet shape or a film shape.

9. The capacitor according to claim 1,
wherein a surface of the current collector of at least one of the pair of electrodes is formed with minute depressions and projections.

10. The capacitor according to claim 1,
wherein the buffer layer of at least one of the pair of electrodes includes a conductive agent.

11. The capacitor according to claim 1,
wherein the polarizable electrode layer of at least one of the pair of electrodes comprises an activated carbon.

12. A capacitor comprising:
a pair of electrodes; and
a separator,
wherein the pair of electrodes opposes each other with the separator sandwiched therebetween in an electrolyte solution,
wherein each of the pair of electrodes includes a current collector, a polarizable electrode layer, and a buffer layer provided between the current collector and the polarizable electrode layer,
wherein the polarizable electrode layer of each of the pair of electrodes comprises an activated carbon, and
wherein the buffer layer of at least one of the pair of electrodes includes fiber shaped carbons.

13. The capacitor according to claim 12, wherein the polarizable electrode layer of at least one of the pair of electrodes is formed by a coating method.

14. The capacitor according to claim 12, wherein the fiber shaped carbons is a carbon nanofiber.

15. The capacitor according to claim 12, wherein the fiber shaped carbons is a carbon nanotube.

16. The capacitor according to claim 15,
wherein the carbon nanotube is a single-wall nanotube.

17. The capacitor according to claim 12,
wherein the buffer layer of at least one of the pair of electrodes includes 60 wt % or more and 90 wt % or less of a carbon nanofiber or a carbon nanotube.

18. The capacitor according to claim 12,
wherein the current collector of each of the pair of electrodes comprises a metal.

19. The capacitor according to claim 12,
wherein the current collector of each of the pair of electrodes is a sheet shape or a film shape.

20. The capacitor according to claim 12,
wherein a surface of the current collector of at least one of the pair of electrodes is formed with minute depressions and projections.

21. The capacitor according to claim 12,
wherein the buffer layer of at least one of the pair of electrodes includes a conductive agent.

22. A capacitor comprising:
a pair of electrodes; and
a separator,
wherein the pair of electrodes opposes each other with the separator sandwiched therebetween in an electrolyte solution,
wherein each of the pair of electrodes includes a current collector, a polarizable electrode layer, and a buffer layer provided between the current collector and the polarizable electrode layer,
wherein the polarizable electrode layer of each of the pair of electrodes comprises an activated carbon,
wherein the polarizable electrode layer of one of the pair of electrodes is added with lithium ion,
wherein the electrolyte solution includes a lithium salt as an electrolyte, and
wherein the buffer layer of at least one of the pair of electrodes includes fiber shaped carbons.

23. The capacitor according to claim 22, wherein the polarizable electrode layer of at least one of the pair of electrodes is formed by a coating method.

24. The capacitor according to claim 22, wherein the fiber shaped carbons is a carbon nanofiber.

25. The capacitor according to claim 22, wherein the fiber shaped carbons is a carbon nanotube.

26. The capacitor according to claim 25,
wherein the carbon nanotube is a single-wall nanotube.

27. The capacitor according to claim 22,
wherein the buffer layer of at least one of the pair of electrodes includes 60 wt % or more and 90 wt % or less of a carbon nanofiber or a carbon nanotube.

28. The capacitor according to claim 22,
wherein the current collector of each of the pair of electrodes comprises a metal.

29. The capacitor according to claim 22,
wherein the current collector of each of the pair of electrodes is a sheet shape or a film shape.

30. The capacitor according to claim 22,
wherein a surface of the current collector of at least one of the pair of electrodes is formed with minute depressions and projections.

31. The capacitor according to claim 22,
wherein the buffer layer of at least one of the pair of electrodes includes a conductive agent.
